(19) United States
(12) Patent Application Publication
(10) Pub. No.: US 2025/0111195 A1
(43) Pub. Date: Apr. 3, 2025

(54) SYSTEMS AND METHODS FOR MODEL ENSEMBLE ACCELERATION

(71) Applicant: Advanced Micro Devices, Inc., Santa Clara, CA (US)

(72) Inventors: Karthik Ramu Sangaiah, Bellevue, WA (US); Yao Cui Fehlis, Austin, TX (US)

(73) Assignee: Advanced Micro Devices, Inc., Santa Clara, CA (US)

(21) Appl. No.: 18/478,639

(22) Filed: Sep. 29, 2023

(51) Int. Cl. G06N 3/045; G06N 3/063

(52) U.S. Cl. CPC G06N 3/045; G06N 3/063

(57) ABSTRACT

Disclosed is a computer-implemented method for model ensemble acceleration in an active learning loop. The method includes receiving a set of datapoint inputs, where each datapoint input is an unlabeled equivalent of other datapoint inputs in the set of datapoint inputs and has a different applied weight value. The method then executes a set of neural network models, where the execution of each neural network model is based on the received set of datapoint inputs. The outputs from the set of neural network models are analyzed, where an inference computation is performed, and a label for the set of datapoints is determined. The method then stores the labeled set of datapoint inputs in a database. Various other methods, systems, and computer-readable media are also disclosed.

### BACKGROUND

Active learning is a machine learning technique in which a model selects a subset of the most informative data points to be labeled in order to improve its accuracy.

### SUMMARY

As will be described in greater detail below, the present disclosure describes various systems and methods for model ensemble acceleration in an active learning loop.

According to some embodiments, a method is disclosed, which can include executing, by a device, a set of neural network models, the execution of each of the set of neural network models being based on an input including a received set of datapoint inputs, each datapoint input being an unlabeled equivalent of other datapoint inputs in the set of datapoint inputs, each datapoint input having a different applied weight value; analyzing, by the device, outputs from the set of neural network models, the analysis including performing an inference computation based on a deviation among the outputs, and determining, based on the inference computation, a label for the set of datapoint inputs; and storing, by the device, the labeled set of datapoint inputs in a database.

In some embodiments, the label of the set of datapoint inputs includes an indication that the deviation of the outputs is within a threshold value.

According to some embodiments, the method can further include training the set of neural network models based on the labeled set of datapoints.

In some embodiments, the label of the set of datapoints includes an indication that the deviation of the outputs is beyond a threshold value, where the labeled set of data requires further retraining prior to use by the set of neural network models.

According to some embodiments, the method can further include merging, by the device, the outputs from the set of neural network models, where the analysis is based on the merged outputs.

In some embodiments, the set of neural network models are part of a systolic array.

In some embodiments, each of the neural network models include a shape, where the shape is similar for each neural network model.

According to some embodiments, the method can further include querying data samples stored within the database, where the received set of datapoint inputs corresponds to a result of the query.

In one example, a system can include at least one physical processor and physical memory including computer-executable instructions, that when executed by the physical processor, cause the physical processor to execute steps including: executing a set of neural network models, the execution of each of the set of neural network models being based on an input including a received set of datapoint inputs, each datapoint input being an unlabeled equivalent of other datapoint inputs in the set of datapoint inputs, each datapoint input having a different applied weight value; analyzing, outputs from the set of neural network models, the analysis including performing an inference computation based on a deviation among the outputs, and determining, based on the inference computation, a label for the set of datapoint inputs; and storing the labeled set of datapoint inputs in a database.

In some examples, the above-described method can be encoded as computer-readable instructions on a non-transitory computer-readable medium. For example, a computer-readable medium can include one or more computer-executable instructions that, when executed by at least one processor of a computing device, can cause the computing device to perform steps including: executing a set of neural network models, the execution of each of the set of neural network models being based on an input including a received set of datapoint inputs, each datapoint input being an unlabeled equivalent of other datapoint inputs in the set of datapoint inputs, each datapoint input having a different applied weight value; analyzing, outputs from the set of neural network models, the analysis including performing an inference computation based on a deviation among the outputs, and determining, based on the inference computation, a label for the set of datapoint inputs; and storing the labeled set of datapoint inputs in a database.

Features from any of the embodiments described herein can be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of example embodiments and are a part of the specification. Together with the following description, these drawings demonstrate and explain various principles of the present disclosure.

FIG. 1 is a block diagram of an example system for model ensemble acceleration according to some embodiments of the present disclosure.

FIG. 2 is a block diagram of an additional example system for model ensemble acceleration according to some embodiments of the present disclosure.

FIG. 3 is a flow diagram of an example method for model ensemble acceleration according to some embodiments of the present disclosure.

FIG. 4 illustrates a non-limiting example embodiment for performing the model ensemble acceleration according to some embodiments of the present disclosure.

FIG. 5 illustrates a non-limiting example embodiment for performing the model ensemble acceleration according to some embodiments of the present disclosure.

Throughout the drawings, identical reference characters and descriptions indicate similar, but not necessarily identical, elements. While the example embodiments described herein are susceptible to various modifications and alternative forms, specific embodiments have been shown by way of example in the drawings and will be described in detail herein. However, the example embodiments described herein are not intended to be limited to the particular forms disclosed. Rather, the present disclosure covers all modifications, equivalents, and alternatives falling within the scope of the appended claims.

### DETAILED DESCRIPTION OF EXAMPLE IMPLEMENTATIONS

Active learning is the process of using a machine learning inference to filter new unlabeled data from a database for data that is not well represented in a machine learning (ML) model. Active learning involves labeling the data in a manner that will have the highest impact on retraining the model to better represent new data. A major part of the active learning loop is to evaluate the model prediction by measuring the disagreements among multiple models in a model ensemble. These model ensemble models may be large enough to occupy all of the hardware resources of an inference accelerator, necessitating serial computing of the model inference one at a time.

Accordingly, the disclosed systems and methods provide a novel model ensemble accelerator, which, in some embodiments, embodies a modified systolic array-based ASIC (application-specific integrated circuit) that can re-use input values across ensemble models. Thus, as discussed herein, in some embodiments, each of the models within the ensemble are capable of and/or configured to simultaneously process input data within the same processing elements. This, among other benefits, enables a reduction in latency of model ensemble inferences and a reduction in power of implemented computer environments, as well as an increased efficiency and accuracy of the ensemble's implementation.

Ensembles of ML models embody the critical compute components of active learning sampling algorithms, which are essential in ML-assisted scientific computing. An ensemble of models can be trained and used for an ensemble disagreement measure to quantify uncertainty when sampling data from a database. Thus, as discussed herein, the disclosed systems and methods provide a specialized ML-assisted scientific computing framework that can quickly and efficiently process the ensemble network kernels that are essential to active learning sampling algorithms employed within scientific computing environments.

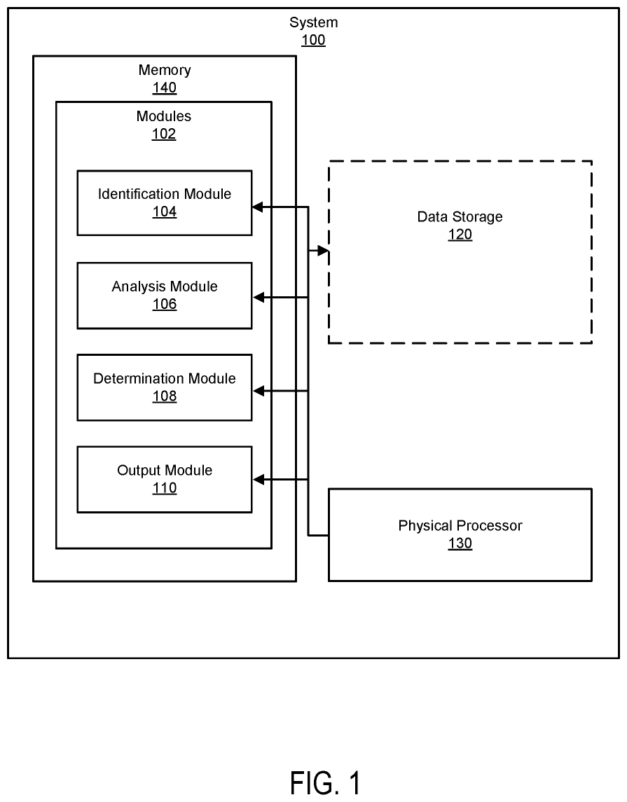

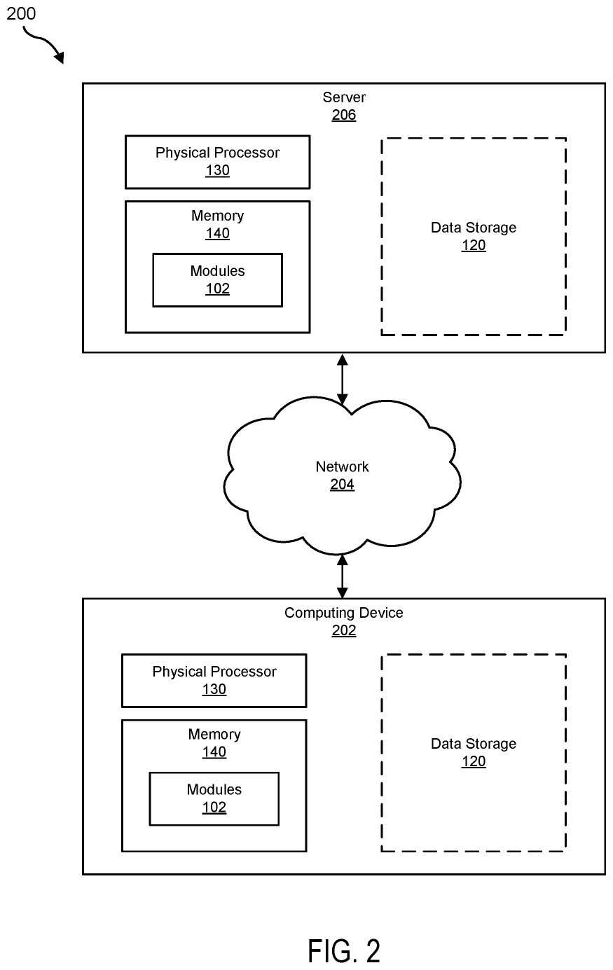

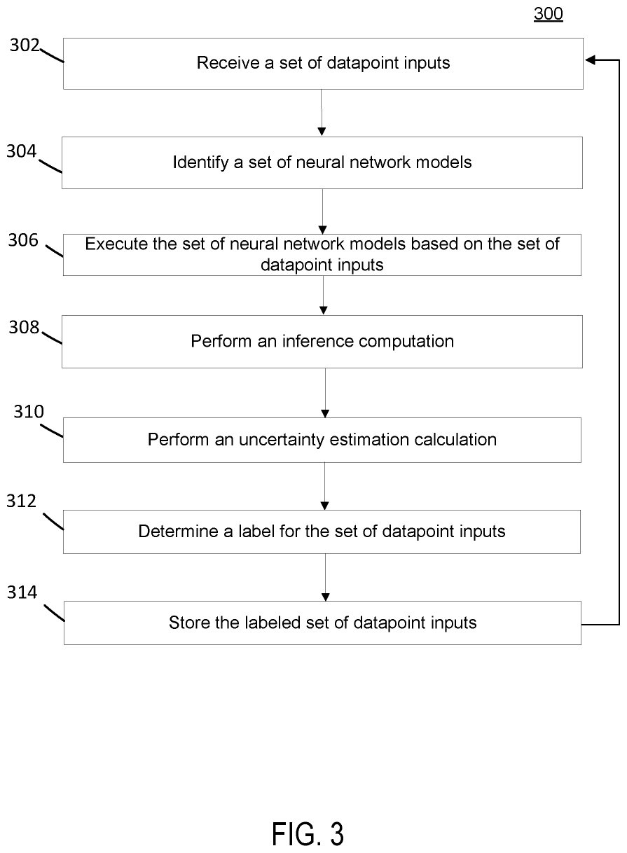

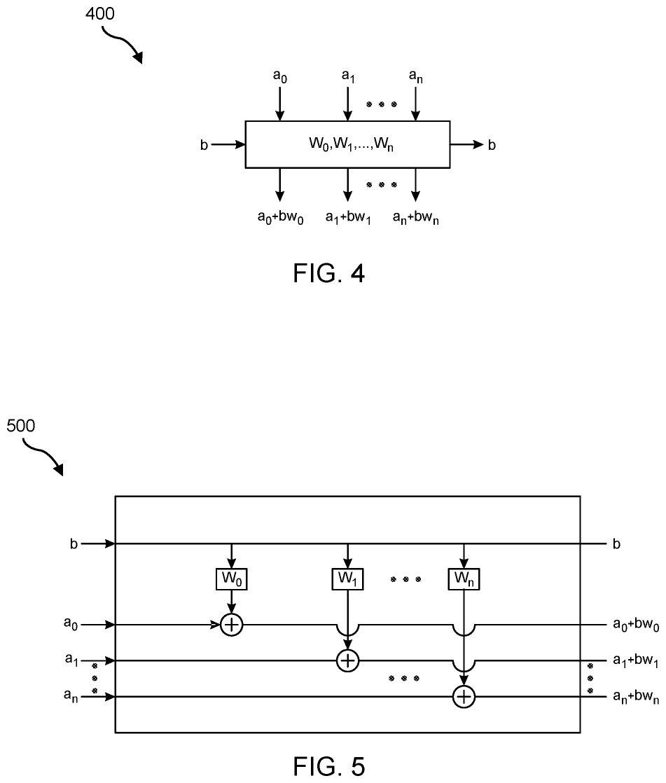

The following will provide, with reference to FIGS. 1 and 2, detailed descriptions of example systems for model ensemble acceleration. Detailed descriptions of corresponding computer-implemented methods will also be provided in connection with FIG. 3. In addition, detailed descriptions of example embodiments related to the processing provided in FIG. 3 are provided in FIG. 4 and FIG. 5.

FIG. 1 is a block diagram of an example system 100 for model ensemble acceleration. As illustrated in this figure, example system 100 can include one or more modules 102 for performing one or more tasks. As will be explained in greater detail below, modules 102 can include an identification module 104, an analysis module 106, a determination module 108, and an output module 110. Although illustrated as separate elements, one or more of modules 102 in FIG. 1 can represent portions of a single module or application.

In certain implementations, one or more of modules 102 in FIG. 1 can represent one or more software applications or programs that, when executed by a computing device, can cause the computing device to perform one or more tasks. For example, and as will be described in greater detail below, one or more of modules 102 can represent modules stored and configured to run on one or more computing devices, such as the devices illustrated in FIG. 2 (e.g., computing device 202 and/or server 206). One or more of modules 102 in FIG. 1 can also represent all or portions of one or more special-purpose computers configured to perform one or more tasks.

As illustrated in FIG. 1, example system 100 can also include one or more memory devices, such as memory 140. Memory 140 generally represents any type or form of volatile or non-volatile storage device or medium capable of storing data and/or computer-readable instructions. In one example, memory 140 can store, load, and/or maintain one or more of modules 102. Examples of memory 140 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

As illustrated in FIG. 1, example system 100 can also include one or more physical processors, such as physical processor 130. Physical processor 130 generally represents any type or form of hardware-implemented processing unit capable of interpreting and/or executing computer-readable instructions. In one example, physical processor 130 can access and/or modify one or more of modules 102 stored in memory 140. Additionally or alternatively, physical processor 130 can execute one or more of modules 102 to facilitate model ensemble acceleration. Examples of physical processor 130 include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

As illustrated in FIG. 1, example system 100 can also include one or more instances of stored data, such as data storage 120. Data storage 120 generally represents any type or form of stored data. In one example, data storage 120 includes databases, spreadsheets, tables, lists, matrices, trees, or any other type of data structure. Examples of data storage 120 include, without limitation, data inputs, weights, neural network identifiers, and the like, or some combination thereof, as discussed below at least in relation to FIG. 3, inter alia.

Example system 100 in FIG. 1 can be implemented in a variety of ways. For example, all or a portion of example system 100 can represent portions of example system 200 in FIG. 2. As shown in FIG. 2, system 200 can include a computing device 202 in communication with a server 206 via a network 204. In one example, all or a portion of the functionality of modules 102 can be performed by computing device 202, server 206, and/or any other suitable computing system. As will be described in greater detail below, one or more of modules 102 from FIG. 1 can, when executed by at least one processor of computing device 202 and/or server 206, enable computing device 202 and/or server 206 to perform model ensemble acceleration.

Computing device 202 generally represents any type or form of computing device capable of reading computer-executable instructions. For example, computing device 202 is any computer capable of receiving, processing, and storing data. Additional examples of computing device 202 include, without limitation, laptops, tablets, desktops, servers, cellular phones, Personal Digital Assistants (PDAs), multimedia players, embedded systems, wearable devices (e.g., smart watches, smart glasses, etc.), smart vehicles, so-called Internet-of-Things (IoT) devices (e.g., smart appliances, etc.), gaming consoles, variations or combinations of one or more of the same, or any other suitable computing device.

Server 206 generally represents any type or form of computing device that is capable receiving, processing, and storing data. Additional examples of server 206 include, without limitation, storage servers, database servers, application servers, and/or web servers configured to run certain software applications and/or provide various storage, database, and/or web services. Although illustrated as a single entity in FIG. 2, server 206 can include and/or represent a plurality of servers that work and/or operate in conjunction with one another.

Network 204 generally represents any medium or architecture capable of facilitating communication or data transfer. In one example, network 204 can facilitate communication between computing device 202 and server 206. In this example, network 204 can facilitate communication or data transfer using wireless and/or wired connections. Examples of network 204 include, without limitation, an intranet, a Wide Area Network (WAN), a Local Area Network (LAN), a Personal Area Network (PAN), the Internet, Power Line Communications (PLC), a cellular network (e.g., a Global System for Mobile Communications (GSM) network), portions of one or more of the same, variations or combinations of one or more of the same, or any other suitable network.

In various examples, many other devices or subsystems are connected to system 100 in FIG. 1 and/or system 200 in FIG. 2. Conversely, all of the components and devices illustrated in FIGS. 1 and 2 need not be present to practice the implementations described and/or illustrated herein. The devices and subsystems referenced above also are interconnected in different ways from that shown in FIG. 2. Systems 100 and 200 also employ any number of software, firmware, and/or hardware configurations. For example, one or more of the example implementations disclosed herein can be encoded as a computer program (also referred to as computer software, software applications, computer-readable instructions, and/or computer control logic) on a computer-readable medium.

The term “computer-readable medium,” as used herein, generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

FIG. 3 is a flow diagram of an example computer-implemented method 300 for model ensemble acceleration in an active learning loop. The steps shown in FIG. 3 can be performed by any suitable computer-executable code and/or computing system, including system 100 in FIG. 1, system 200 in FIG. 2, and/or variations or combinations of one or more of the same. In one example, each of the steps shown in FIG. 3 can represent an algorithm whose structure includes and/or is represented by multiple sub-steps, examples of which will be provided in greater detail below.

By way of background, in scientific computing, ML models can be used as surrogate models to predict physical properties that are traditionally computed through physical simulations. To acquire the labels of the training data for such ML models, traditional physical simulations are typically carried out on CPUs. Once an ML-based surrogate model fails to predict properly, retraining the model is needed.

By choosing the unlabeled data intelligently, active learning can filter and select only the unlabeled data that the surrogate model needs to better represent a new dataset. According to some embodiments, as discussed herein, in an active learning process, a query strategy framework can be used to select the most informative samples from the database where it contains unlabeled data. These frameworks include, but are not limited to, uncertainty sampling, query-by-committee (QBC), expected error reduction, and the like.

For example, using query-by-committee as a framework, the committee can be made of a model ensemble that performs inferencing on data samples from the database. In some embodiments, an uncertainty estimation, such as vote entropy or standard deviation related features, can be computed to measure the disagreements within the committee. If the uncertainty estimation is above a certain threshold, the data sample can be selected, and its label will be computed through traditional physical simulations. According to some embodiments, only selected data samples can be added into the training set for retraining the model.

Since a major part of an active learning loop is to evaluate the model prediction by using a model ensemble, the model ensemble can include a certain number of the same neural network models. In some embodiments, the weights of the models in the ensemble can be initialized differently, for example, by using different random seeds, or using different training data. In some embodiments, however, the models in the ensemble can have the exact same structure. Accordingly, the challenge in this approach, solved by the disclosed systems and methods discussed herein, is the model ensemble models may be large enough to occupy most or all of the hardware resources of an inference accelerator, necessitating serial computing of the model inference one at a time, increasing the latency per query, as discussed above.

Accordingly, in some embodiments, the key operations in the disclosed model ensemble inference can involve performing/computing an inference on an unlabeled data query for N-number of ML models and then quantifying uncertainty in the results across the ML models. In some embodiments, for large models that occupy all of the hardware resources of the inference computation unit, each of these N models can perform inference independently—for example, either each model can perform inference sequentially one by one on a given hardware platform (e.g. GPU or TPU), or multiple of the N models can perform inference on multiple hardware platforms in parallel.

Accordingly, the instant disclosure details a computerized, technical solution of performing inference on N models in parallel using a single accelerator design based on a systolic array that specifically exploits input re-use.

According to some embodiments, as discussed herein, Steps 302-304 of method 300 can be performed by identification module 104; Step 306 can be performed by analysis module 106; Steps 308-312 can be performed by determination module 108; and Step 314 can be performed by output module 110.

According to some embodiments, method 300 begins with Step 302 where a set of datapoint inputs are received (or identified). According to some embodiments, Step 302 involves the identification of a new unlabeled dataset being randomly selected from a database. In some embodiments, the quantity of the datapoints in the dataset can be a predetermined value and/or can be proportional to a number of ML models within an ensemble model. In some embodiments, as discussed above, each of the datapoints can have a different applied weight value (e.g., datapoint 1 has W₁, and datapoint 2 has W₂, for example).

In Step 304, a set of neural network models are identified. As discussed above, an ensemble model includes a set of ML models; therefore, according to some embodiments, Step 304 can involve the identification of a set of ML models (e.g., neural network models).

According to some embodiments, while the discussion herein will focus on ML models being neural network models, it should not be construed as limiting, as it should be recognized that an ML model can be any type of known or to be known ML model that is capable of being part of an ensemble model without departing from the scope of the instant disclosure. For example, the ML models can be, but are not limited to, convolutional neural network (CNN), recurrent neural network (RNN), autoencoder, support vector machine (SVM), and the like, or any other suitable definition of a machine learning model or any suitable combination thereof. Moreover, other ML or artificial intelligence (AI) models can be utilized without departing from the scope of the instant disclosure, for example, but not limited to, computer vision, feature vector analysis, decision trees, boosting, support-vector machines, neural networks, nearest neighbor algorithms, Naive Bayes, bagging, random forests, logistic regression, and the like. Thus, it should be readily recognized that while the ML models within the ensemble model are referenced as neural networks, they are not so limiting.

In Step 306, the ensemble model (e.g., set of neural network models) is executed based on the set of datapoint inputs (from Step 302). In some embodiments, the set of neural network models are part of a systolic array. Accordingly, in some embodiments, the execution of Step 306 can involve the datapoints (from Step 302) being input to the ensemble of neural networks of the same topology but of different weights. This provides a neural network accelerator configuration/framework that can exploit the input re-use and can run N neural network inferences simultaneously.

Accordingly, as in Step 308, the set of neural networks within the ensemble, realized via the systolic array, can utilize, for example, matrix multiplication units to efficiently compute multiple inferences by i) supporting multiple executable (e.g., portable) lanes, repeated by the number of neural networks in the ensemble, ii) augmenting the processing element multiply-and-accumulate operator to process N simultaneous intermediate accumulations and multiplies across the same single input data, and iii) add a merger lane to compute the uncertainty across the N ensemble models. Thus, in Step 308, based on execution of the ensemble model in Step 306, an inference computation(s) is performed.

According to some embodiments, the inference computations of Step 308 can be performed on the data through the ensemble of neural networks. As discussed above, the ensemble of N neural network models contains equivalent topologies but differing weights. Accordingly, an inference result can be produced using the same input data (from Step 302) on each of the N neural network models, and these N results can be compared in order to determine an estimate of an uncertainty score across the N neural network models, as in Step 310.

Thus, in Step 310, the determined uncertainty estimation calculations can be calculated based on the inference computations of Step 308. As discussed above, such calculations can provide indicators as to deviations and/or discrepancies among the outputs from the ensemble model.

In FIG. 4, according to some embodiments, provided is example 400 that depicts computations capable of being performed by the ensemble for determination of the disclosed inferences. FIG. 4 depicts operations within the disclosed systolic array for ensemble inference determinations. In a systolic array arrangement, the a values correspond to partial products to be summed, and b values correspond to values from the input matrix. Accordingly, each of the N partial products from each of the ensemble of N neural networks can be passed into each lane of the ensemble along with the single unlabeled data input, represented by b.

In some embodiments, according to another non-limiting example, in FIG. 5, input b is multiplied across all the weights of the N neural networks, and each partial product is added to the passed in partial products of a₀ to aₙ. As an embodiment to this configuration, the depiction of example 500 in FIG. 5 enables an extension of the configuration to cover any number of neural networks in an ensemble. In some embodiments, weights, input lanes and corresponding multiplexors can be implemented as a reconfigurable pool, which can be configured based on how many models in the ensemble need to be supported.

Turning back to FIG. 3, processing of method 300 proceeds from Step 310 to Step 312 where a determination is made as to a label for the set of datapoint inputs. The label determination is based on the inference computation and uncertainty estimation from Steps 308-310.

In some embodiments, when the computed inference corresponds to an uncertainty score exceeding a predetermined threshold, the unlabeled data can be determined to fall outside of the representation of the neural network models. Therefore, Step 312 can involve labelling the input datapoints for retraining. Accordingly, an indication can be stored in a database (as provided in Step 314), whereby queuing, batching and retraining can be provided/executed via the ensemble, as indicated by the feedback loop from Step 314 to Step 302 in FIG. 3. In some embodiments, the unlabeled data can be batched within a queue until a threshold quantity of datapoints are identified for retraining.

In some embodiments, when the computed inference corresponds to an uncertainty score being equal to or below the predetermined threshold, the input data can be labeled as qualified data and stored in the database, as in Step 314. In some embodiments, such datapoints can be filtered so as to enable representation of the data within the ensemble model.

As such, according to some embodiments, method 300 provides an augmented systolic array framework that is capable of performing inferences against N ML models within an ensemble model simultaneously, which provides capabilities for back-to-back streaming of data input queries within the model ensemble.

While the foregoing disclosure sets forth various implementations using specific block diagrams, flowcharts, and examples, each block diagram component, flowchart step, operation, and/or component described and/or illustrated herein can be implemented, individually and/or collectively, using a wide range of hardware, software, or firmware (or any combination thereof) configurations. In addition, any disclosure of components contained within other components should be considered example in nature since many other architectures can be implemented to achieve the same functionality.

In some examples, all or a portion of example system 100 in FIG. 1 can represent portions of a cloud-computing or network-based environment. Cloud-computing environments can provide various services and applications via the Internet. These cloud-based services (e.g., software as a service, platform as a service, infrastructure as a service, etc.) can be accessible through a web browser or other remote interface. Various functions described herein can be provided through a remote desktop environment or any other cloud-based computing environment.

In various implementations, all or a portion of example system 100 in FIG. 1 can facilitate multi-tenancy within a cloud-based computing environment. In other words, the modules described herein can configure a computing system (e.g., a server) to facilitate multi-tenancy for one or more of the functions described herein. For example, one or more of the modules described herein can program a server to enable two or more clients (e.g., customers) to share an application that is running on the server. A server programmed in this manner can share an application, operating system, processing system, and/or storage system among multiple customers (i.e., tenants). One or more of the modules described herein can also partition data and/or configuration information of a multi-tenant application for each customer such that one customer cannot access data and/or configuration information of another customer.

According to various implementations, all or a portion of example system 100 in FIG. 1 can be implemented within a virtual environment. For example, the modules and/or data described herein can reside and/or execute within a virtual machine. As used herein, the term “virtual machine” generally refers to any operating system environment that is abstracted from computing hardware by a virtual machine manager (e.g., a hypervisor).

In some examples, all or a portion of example system 100 in FIG. 1 can represent portions of a mobile computing environment. Mobile computing environments can be implemented by a wide range of mobile computing devices, including mobile phones, tablet computers, e-book readers, personal digital assistants, wearable computing devices (e.g., computing devices with a head-mounted display, smartwatches, etc.), variations or combinations of one or more of the same, or any other suitable mobile computing devices. In some examples, mobile computing environments can have one or more distinct features, including, for example, reliance on battery power, presenting only one foreground application at any given time, remote management features, touchscreen features, location and movement data (e.g., provided by Global Positioning Systems, gyroscopes, accelerometers, etc.), restricted platforms that restrict modifications to system-level configurations and/or that limit the ability of third-party software to inspect the behavior of other applications, controls to restrict the installation of applications (e.g., to only originate from approved application stores), etc. Various functions described herein can be provided for a mobile computing environment and/or can interact with a mobile computing environment.

The process parameters and sequence of steps described and/or illustrated herein are given by way of example only and can be varied as desired. For example, while the steps illustrated and/or described herein can be shown or discussed in a particular order, these steps do not necessarily need to be performed in the order illustrated or discussed. The various example methods described and/or illustrated herein can also omit one or more of the steps described or illustrated herein or include additional steps in addition to those disclosed.

While various implementations have been described and/or illustrated herein in the context of fully functional computing systems, one or more of these example implementations can be distributed as a program product in a variety of forms, regardless of the particular type of computer-readable media used to actually carry out the distribution. The implementations disclosed herein can also be implemented using modules that perform certain tasks. These modules can include script, batch, or other executable files that can be stored on a computer-readable storage medium or in a computing system. In some implementations, these modules can configure a computing system to perform one or more of the example implementations disclosed herein.

The preceding description has been provided to enable others skilled in the art to best utilize various aspects of the example implementations disclosed herein. This example description is not intended to be exhaustive or to be limited to any precise form disclosed. Many modifications and variations are possible without departing from the spirit and scope of the present disclosure. The implementations disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A method comprising:
executing, by a device, a set of neural network models, the execution of each of the set of neural network models being based on an input comprising a received set of datapoint inputs, each datapoint input being an unlabeled equivalent of other datapoint inputs in the set of datapoint inputs, each datapoint input having a different applied weight value;
analyzing, by the device, outputs from the set of neural network models by:
performing an inference computation based on a deviation among the outputs, and
determining, based on the inference computation, a label for the set of datapoint inputs; and
storing, by the device, the labeled set of datapoint inputs in a database.

2. The method of claim 1, wherein the label of the set of datapoint inputs comprises an indication that the deviation of the outputs is within a threshold value.

3. The method of claim 2, further comprising:
training the set of neural network models based on the labeled set of datapoints.

4. The method of claim 1, wherein the label of the set of datapoint inputs comprises an indication that the deviation of the outputs is beyond a threshold value, wherein the labeled set of datapoint inputs requires further retraining prior to use by the set of neural network models.

5. The method of claim 1, further comprising:
merging, by the device, the outputs from the set of neural network models, wherein the analysis of the outputs is based on the merged outputs.

6. The method of claim 1, wherein the set of neural network models are part of a systolic array.

7. The method of claim 1, wherein each of the neural network models comprise a shape, wherein the shape is similar for each neural network model.

8. The method of claim 1, further comprising:
querying data samples stored within the database, wherein the received set of datapoint inputs corresponds to a result of the query.

9. A system comprising:
at least one integrated circuit configured to:
execute a set of neural network models, the execution of each of the set of neural network models being based on an input comprising a received set of datapoint inputs, each datapoint input being an unlabeled equivalent of other datapoint inputs in the set of datapoint inputs, each datapoint input having a different applied weight value;
analyze outputs from the set of neural network models, the analysis of the outputs comprising performing an inference computation based on a deviation among the outputs, and determining, based on the inference computation, a label for the set of datapoint inputs; and
store the labeled set of datapoint inputs in a database.

10. The system of claim 9, wherein the label of the set of datapoint inputs comprises an indication that the deviation of the outputs is within a threshold value.

11. The system of claim 10, wherein the integrated circuit is further configured to:
train the set of neural network models based on the labeled set of datapoints.

12. The system of claim 9, wherein the label of the set of datapoint inputs comprises an indication that the deviation of the outputs is beyond a threshold value, wherein the labeled set of datapoint inputs requires further retraining prior to use by the set of neural network models.

13. The system of claim 9, wherein the instructions further cause the physical processor to:
merge the outputs from the set of neural network models, wherein the analysis is based on the merged outputs.

14. The system of claim 9, wherein the set of neural network models are part of a systolic array.

15. The system of claim 9, wherein each of the neural network models comprise a shape, wherein the shape is similar for each neural network model.

16. The system of claim 9, wherein the integrated circuit is further configured to:
querying data samples stored within the database, wherein the received set of datapoint inputs corresponds to a result of the query.

17. A non-transitory computer-readable medium comprising one or more computer-executable instructions that, when executed by at least one processor of a computing device, performs a method comprising:
executing a set of neural network models, the execution of each of the set of neural network models being based on an input comprising a received set of datapoint inputs, each datapoint input being an unlabeled equivalent of other datapoint inputs in the set of datapoint inputs, each datapoint input having a different applied weight value;
analyzing outputs from the set of neural network models, the analysis comprising performing an inference computation based on a deviation among the outputs, and determining, based on the inference computation, a label for the set of datapoint inputs; and
storing the labeled set of datapoint inputs in a database.

18. The non-transitory computer-readable medium of claim 17, wherein the label of the set of datapoint inputs comprises an indication that the deviation of the outputs is within a threshold value.

19. The non-transitory computer-readable medium of claim 17, wherein the label of the set of datapoint inputs comprises an indication that the deviation of the outputs is beyond a threshold value, wherein the labeled set of datapoint inputs requires further retraining prior to use by the set of neural network models.

20. The non-transitory computer-readable medium of claim 17, further comprising:
merging the outputs from the set of neural network models, wherein the analysis is based on the merged outputs.
